(19) United States
(12) Patent Application Publication
(10) Pub. No.: US 2002/0126999 A1
(43) Pub. Date: Sep. 12, 2002

(54) Video/audio information recording/playback apparatus and method

(76) Inventors: Masayoshi Shimamoto, Tokyo (JP); Masafumi Kodama, Tokyo (JP); Kazuhiko Nakane, Tokyo (JP); Tomohide Okumura, Tokyo (JP); Yoshinori Watanabe, Tokyo (JP); Takayuki Sawami, Hyogo (JP); Kazutaka Kijima, Hyogo (JP)

Correspondence Address: BIRCH STEWART KOLASCH & BIRCH, PO BOX 747, FALLS CHURCH, VA, 22040-0747, US

(21) Appl. No.: 10/093,735

(22) Filed: Mar. 11, 2002

(30) Foreign Application Priority Data
Mar. 12, 2001 (JP) 2001-068234

(51) Int. Cl. H04N 5/91; H04N 7/04; H04N 7/06; H04N 7/08; H04N 7/52

(52) U.S. Cl. 386/96

(57) ABSTRACT

In a video/audio information recording/playback apparatus and method for recording programs in a recording medium in accordance with reservation information, and reproducing the recorded programs, attribute information for grouping a plurality of programs recorded according to reservation information is added to each of the programs recorded according to the reservation information. In addition, the number of programs constituting a unit of processing is set, and information representing the above-mentioned number of programs is recorded together with the program recorded according to the reservation information. A new program is recorded, while preserving the previously recorded program or programs, until the number of recorded programs belonging to the same group reaches the above-mentioned number of programs constituting the unit of processing. After that, a new program is recorded in replacement of an old program of the same group. In reservation for periodic recording, the number of programs within a predetermined period, e.g., a week, may be automatically set as the above-mentioned number of programs, which may thereafter be altered by user input.

### BACKGROUND OF THE INVENTION

1. Field of the Invention

The present invention relates to a video/audio information recording/playback apparatus and method for recording broadcast programs containing video/audio information (video and audio information, or video information, or audio information) in a recording medium in accordance with reservation information for recording, and playing back the recorded programs.

2. Conventional Art

Conventional video/audio information recording/playback apparatus include video tape recorders (hereinafter referred to as VTRs), and disk recorders using disk medium such as optical disks, e.g., DVD or magnetic disks such as the ones for HDD. Recording reservation for recording by such video/audio information recording/playback apparatus can be made, by a method in which starting time and ending time of recording, recorded channel are set using a reservation list displayed on a television set, or a method in which a numerical sequence (G-code) which corresponds to each program, and which is indicated in a program guide of a newspaper, or the like is input. Moreover, video/audio information recording/playback apparatus are now available by which, by setting the recording day as “everyday,” “every week,” “Monday, Tuesday, Wednesday, Thursday, and Friday,” “Monday, Tuesday, Wednesday, Thursday, Friday, and Saturday,” “Saturday and Sunday,” or the like, the programs can be recorded periodically based on a single reservation setting.

FIG. 6 shows an example of conventional video/audio information recording/playback apparatus which is a VTR shown in Japanese Patent Kokai Publication No. H09-163280. In FIG. 6, reference numeral 1 denotes a VTR (conventional video/audio information recording/playback apparatus), reference numeral 101 denotes an antenna for receiving broadcast radio waves, and reference numeral 102 denotes a television set. In VTR 1, reference numeral 104 denotes a video/audio processor for modulating (in a recording mode) and demodulating (in a playback mode) video information and audio information, reference numeral 105 denotes a playback amplifier, reference numeral 106 denotes a recording amplifier, reference numeral 107 denotes a cylinder for recording and reproducing video information and audio information, reference numeral 108 denotes a cylinder driver for rotating the cylinder 107, reference numeral 109 denotes a tape on which video information and audio information are magnetically recorded, reference numeral 110 denotes a capstan motor for transporting the tape 109, and reference numeral 111 denotes a capstan driver for rotating the capstan motor 110. Reference numeral 112 denotes a control head for recording control signals on a linear control track formed on a tape 109, and detecting the recorded control signals. Reference numeral 113 denotes a counter calculating unit for counting the control signals detected by the control head 112 and calculating the amount of travel of the tape 109, and reference numeral 115 denotes a time calculating unit for counting or measuring the time.

In FIG. 6, reference numeral 2 denotes a head recording/detecting unit for recording and detecting record starting information, reference numeral 3 denotes a recording/playback manager which receives reservation information including recording time and channel number, responsive to the input by the user, and outputs commands “record,” “playback,” “stop,” and the like at the reserved time. Reference numeral 4 denotes a memory for storing recording times and channel numbers from the recording/playback manager 3, and reference numeral 6 denotes a video synthesizer for synthesizing video information and superimposed captions and the like. Reference numeral 5 denotes a system controlling unit which receives the commands such as “record,” “playback,” and “stop” from the recording/playback manager 3, and controls the cylinder driver 108 and the capstan driver 112 based on the control signals from the control head 112, and switches the video/audio processor 104 between a playback mode and a recording mode.

FIG. 7 is a flowchart illustrating the reservation setting operation and reserved recording operation by the conventional video/audio information recording/playback apparatus of FIG. 6. FIG. 8 illustrates an example of program recording management information (information of the program for which reserved recording has been set by a user) stored in the conventional video/audio information recording/playback apparatus of FIG. 6.

First, items of FIG. 8, including the “record starting time,” “record ending time,” “television channel,” “recording mode (“everyday,” “Monday, Tuesday, Wednesday, Thursday, and Friday”) input and set by the user are stored in the memory 4 (step 7 in FIG. 7). The amount of tape travel from the tape head at the time of record starting and record stopping is calculated based on the record starting time and the record ending time, to determine the recording position on the tape (step 8), and the “tape travel at the time of each of record starting and record stopping” is stored as the item “tape travel amount” in FIG. 8 (step 9).

When it is time immediately before starting the recording, the tape is rewound or fast-forward-fed, to find (search for) the record starting position (head of the program) based on the tape travel amount at the time of record starting, using the tape travel amount obtained by the counter calculating unit 113 (step 10). In the case of a first recording of a certain program for which reservation recording is to be made, when the finding of (search for) the record starting position is completed, the head signal is recorded on the linear control track at the starting point of the program using the head recording/detecting unit 2 (steps 11 and 12). In the case of a second or subsequent recording of the program, the record starting position is determined in accordance with the detection of the start signal (steps 11 and 13). When it is time to start recording, the recording is started at the record starting position that has been found by the search (step 14). When it is time to stop the recording, the recording is stopped (step 15).

Thus, at the first recording, the head signal is recorded at the record starting position having been found by the search using the tape travel amount obtained by the counter calculating unit 113, and at the second or later recording, the head signal is detected to find the record starting position, so that the second or subsequent recording is started at the same record starting position as the first recording. As a result, the second or subsequent recording is update-recording in the area used for the first recording.

FIG. 9 illustrates the arrangement of programs on the tape and update-recording operation by the conventional video/audio information recording/playback apparatus of FIG. 6. In FIG. 9, reference numeral 23 denotes a tape, reference numerals 24, 25, 26 and 27 denote programs recorded by “selection No. 1,” “selection No. 2,” “selection No. 3,” and “selection No. 4”in FIG. 8. The programs 24 are programs broadcast starting at 1:00 a.m. on Monday, Tuesday, Wednesday, Thursday, and Friday, the programs 25 are programs broadcast starting at 9:00 a.m. everyday, the program 26 is a program broadcast starting at 2:00 p.m. on Sunday, the program 27 is a program broadcast starting at 7:00 p.m. on Friday. Taking a particular day, Friday, for example, the program 24 starts at 1:00 a.m., the program 25 starts at 9:00 a.m., and the program 27 starts at 7:00 p.m. and they are update-recorded in respective predetermined positions.

During playback, when the user selects the desired selection number, the program information (recorded channel, record day, record starting time, ending time, and the like) is displayed on the television set 102, via the video synthesizer 6. When a playback button is next pressed, the head of the program is search for, and the program is played back.

The conventional video/audio information recording/playback apparatus shown in FIG. 6 has the following problems. In the case of reservation for periodic recording (for instance, “everyday,” “every week,” “Monday, Tuesday, Wednesday, Thursday, and Friday,” “Monday, Tuesday, Wednesday, Thursday, Friday, and Saturday,” “Saturday and Sunday,”or the like), the programs recorded periodically are recorded in the same position in the recording medium, so that just one program (per reservation) is maintained in the recording medium, and it is not possible to maintain the respective programs for one period (cycle) or several periods. That is, in the case of reservation for periodic recording, the unit of update processing is automatically set to be one program, and it is not possible to set a unit of update-recording processing so as to consist of a plurality of programs. For instance, it is not possible to maintain five programs broadcast on Monday to Friday in a certain week, until they are replaced by the programs in the next week.

Moreover, when reservation for periodic recording is made, the unit of processing is automatically set to be one program, so that during playback, it is not possible to perform collective playback of only the programs for one period or several periods. Even when reservation is made for each specific day in connection with each of the programs periodically broadcast, it is not possible to perform collective playback of the programs for one period or several periods.

It may therefore not be convenient and satisfactory for the user because the update-recording taking an arbitrary number of programs as a unit cannot be set in reservation for periodic recording (the unit of update-recording processing cannot be set so as to consist of plurality of programs).

Moreover, in reserved periodic update-recording, the position in the recording medium where the particular program is recorded is fixed, so that the recording head must move to the fixed position (in the case of a disk medium), or to make the recording medium to travel until the fixed area confronts the recording head (in the case of video tape or the like) when the recording is started. Accordingly, there is a time lag due to the movement of the recording head or traveling of the medium, and there is a problem in terms of temporal response.

### SUMMARY OF THE INVENTION

The invention has been made to solve the problems described above, and its object is to provide a video/audio information recording/playback apparatus by which update-recording can be made, taking an arbitrary number of programs as a unit, e.g., in reservation for periodic recording.

Another object is to provide a video/audio information recording/playback apparatus which can perform collective and consecutive playback of only the plurality of programs recorded by the update-recording taking the arbitrary number of programs as a unit.

A further object is to improve the temporal response at the time of starting recording.

A video/audio information recording/playback apparatus according to the invention is for recording programs containing video/audio information (combination of video and audio information, or video information alone, or audio information alone) in accordance with reservation information for recording, in a recording medium, and playing back the recorded programs. It includes a recording controller, a reservation setting unit, a playback controller, and a playback setting unit. The recording controller controls recording of the programs in a recording medium. The reservation setting unit controls reserved recording operation by the recording controller in accordance with the reservation information. The playback controller controls playback of the programs recorded in the recording medium. The playback setting unit controls the playback operation by the playback controller. The recording controller is capable of adding attribute information for grouping a plurality of programs recorded according to reservation information, to each of the programs recorded according to the reservation information.

With the above arrangement, the programs grouped together can be taken as a unit of processing for the purpose of recording, or for the purpose of playback. For instance, collective playback of only those programs that belong to the same group can be made by referring to the attribute information.

The recording controller may be capable of recording recording mode information indicating whether the program of each group may be recorded in replacement of another program which belongs to the same group and was recorded previously.

With the above arrangement, it is possible to select the method of recording for each group of the programs, between update recording, i.e., recording in replacement of another previously recorded program of the same group, or addition recording, i.e., without replacement of any of the previously recorded programs.

It may be so arranged that, when recording a new program which belongs to a certain group, the recording controller selects the area for recording the new program, by judging whether the new program may be recorded in replacement of another program which belongs to the same group and which was recorded previously, by referring to the recording mode information.

With the above arrangement, it is possible to select the area for recording a new program by referring to the attribute information and the recording mode information of the previously recorded programs, so that it is possible to make full use of the recording capacity of the recording medium without erasing previously recorded programs that should preserved.

The reservation setting unit may be adapted to permit input of information by a user to designate the content of the attribute information, and the recording controller determines the content of the attribute information in response to the information from the reservation setting unit.

With the above arrangement, the user can designate the content of the attribute information by input using the reservation setting unit.

The reservation setting unit may be adapted to permit input of information by a user to designate the content of the recording mode information, and the recording controller determines the content of the recording mode information in response to the information from the reservation setting unit.

With the above arrangement, the user can designate the content of the recording mode information by input using the reservation setting unit.

It may be so arranged that the reservation setting unit is capable of setting the number of programs constituting a unit of update-recording processing, and adds, to the reservation information, information indicating the above-mentioned number of programs. When recording programs by the reservation information, the recording controller records a new program, while preserving the previously recorded program or programs, until the number of recorded programs belonging to the same group reaches the above-mentioned number of programs constituting said unit of update-recording processing, and the recording controller records a new program in replacement of an old program of the same group, after the number of recorded programs has reached the above-mentioned number of programs constituting said unit of update-recording processing.

With the above arrangement, the unit of processing can be enlarged from one program as in the conventional art, to an arbitrary number of programs, so that the apparatus is more convenient to the user.

The reservation setting unit may be adapted to permit setting of the number of programs constituting a unit of update-recording processing, in response to input by a user.

The recording controller may add the attribute information such that a plurality of programs recorded by one common reservation information for periodic recording belong to the same group.

With the above arrangement, grouping is achieved automatically responsive to the reservation for periodic recording, so that no separate input by a user for the purpose of grouping is required.

It may be so arranged that, in reservation for periodic recording, the reservation setting unit automatically sets the number of programs within a predetermined period as a unit of update recording processing. In this case, the reservation setting unit is preferably capable of altering the number of programs constituting said unit of update-recording processing having been set automatically, in response to input by a user.

It may be so arranged that the playback setting unit takes the plurality of programs grouped by the attribute information as one unit of playback processing; and the playback controller performs collective playback of only those grouped programs when said unit of playback processing is selected.

With the above arrangement, it is possible to perform consecutive, or consecutive and cyclic playback of only those programs which have been grouped together by the attribute information and which relate closely to each other, so that the apparatus is even more convenient to the user.

The record controller may record the attribute information together with the program in the recording medium.

With the above arrangement, it is possible to record different programs of one group using different video/audio information recording/playback apparatus, and yet it is possible to playback the programs of the group collectively.

It may be so arranged that the recording controller divides the information recording area of the recording medium into a video/audio information area and a management information area, and records the programs in the video/audio information area, and records management information for the programs in the management information area, and also records the attribute information for the programs recorded according to the reservation information, as part of the management information for the program in the management information area.

With the above arrangement, the temporal response at the time of reading the management information from the recording medium, and rewriting the management information of the recording medium can be improved, and erroneous operation during reading and writing of the management information can be reduced.

It may be so arranged that when recording a new program in replacement of another program which was recorded previously, the recording controller selects the area for recording the new program by means of the reservation information, from among an area where the above-mentioned another program is recorded, and a vacant area; and erases the management information for above-mentioned another program, and records the management information for the new program.

With the above arrangement, it is possible to select the optimum recording area depending on the position of the writing head or the like, so that the temporal response up to the start of actual recording can be improved.

The video/audio information recording/playback apparatus may additionally includes a management information storage being separate from the recording medium, and storing the management information. In this case, the playback controller reproduces the management information from the recording medium and supplies the management information to the management information storage at the time of starting of operation of the video/audio information recording/playback apparatus; the recording controller and the playback controller access the management information storage when it is required to refer to or rewrite the management information during operation of the video/audio information recording/playback apparatus; and the recording controller replaces the management information stored in the recording medium with the management information stored in the management information storage at the time of stopping of the operation of the video/audio information recording/playback apparatus.

With the above arrangement, the temporal response at the time of referring to or rewriting the management information can be improved.

The starting of operation of the video/audio information recording/playback apparatus mentioned above may be turning-on of the power supply to the video/audio information recording/playback apparatus, or insertion of a recording medium into the video/audio information recording/playback apparatus.

The stopping of the operation of the video/audio information recording/playback apparatus mentioned above may be removal of a recording medium from the video/audio information recording/playback apparatus, transition of the video/audio information recording/playback apparatus to a waiting mode, or turning-off of the power supply to the video/audio information recording/playback apparatus.

The recording medium may be a randomly accessible medium.

With the above arrangement, the response up to the operation desired by the user can be improved.

The invention also provides a video/audio information recording/playback method including:

setting reservation information;

recording programs containing video/audio information (combination of video and audio information, or video information alone, or audio information alone) in accordance with the reservation information, in a recording medium; and

adding attribute information for grouping a plurality of programs recorded according to reservation information, to each of the programs recorded according to the reservation information.

The method may further includes:

setting the number of programs constituting a unit of processing;

recording information representing the above-mentioned number of programs together with the program recorded according to the reservation information;

recording a new program, while preserving the previously recorded program or programs, until the number of recorded programs belonging to the same group reaches the above-mentioned number of programs constituting said unit of processing; and

recording a new program in replacement of an old program of the same group, after the number of recorded programs has reached the above-mentioned number of programs constituting said unit of processing.

### BRIEF DESCRIPTION OF THE DRAWINGS

FIG. 1 shows a system configuration of a video/audio information recording/playback apparatus of an embodiment of the invention;

FIG. 2A and FIG. 2B illustrate a reservation list and playback list in the video/audio information recording/playback apparatus of FIG. 1;

FIG. 3 is a flowchart showing the reservation setting procedure by the video/audio information recording/playback apparatus of FIG. 1;

FIG. 4A and FIG. 4B illustrate the update-recording operation of a plurality of programs in a video/audio information recording/playback apparatus of FIG. 1;

FIG. 5 illustrates collective playback operation of a plurality of programs recorded by update-recording, taking a plurality of programs as a unit, by the video/audio information recording/playback apparatus of FIG. 1;

FIG. 6 shows a system configuration of a conventional video/audio information recording/playback apparatus;

FIG. 7 is a flowchart illustrating reservation setting operation and reserved-recording operation of the video/audio information recording/playback apparatus of FIG. 6;

FIG. 8 shows an example of program recording management information stored in the video/audio information recording/playback apparatus of FIG. 6; and

FIG. 9 shows the arrangement of programs on the tape and update-recording operation by the video/audio information recording/playback apparatus of FIG. 6.

### DETAILED DESCRIPTION OF THE PREFERRED EMBODIMENTS

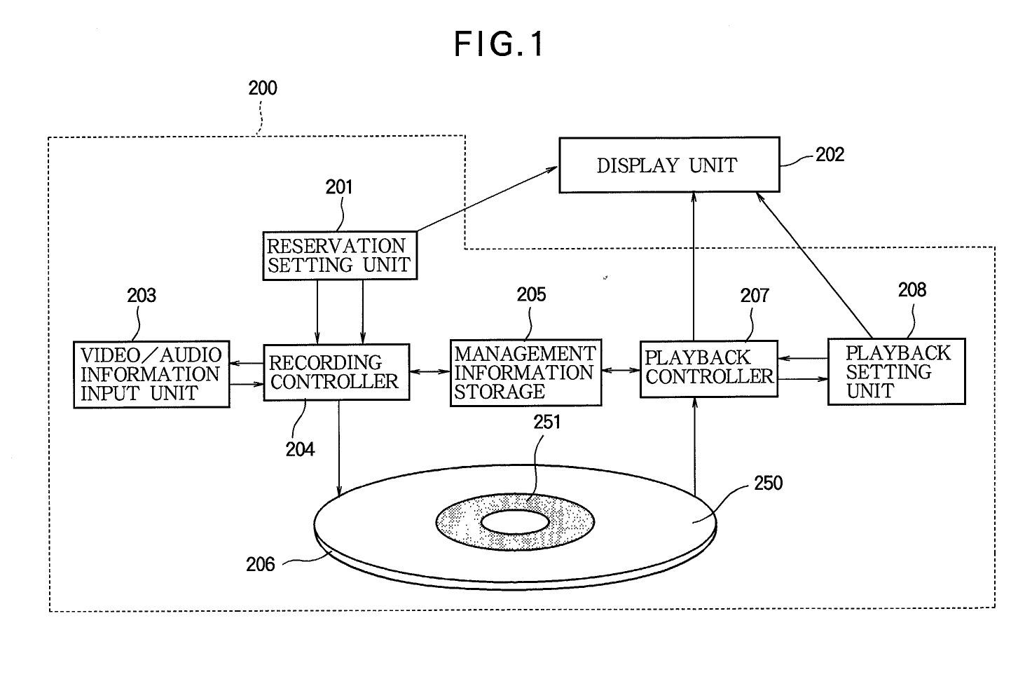

FIG. 1 shows a system configuration of a video/audio information recording/playback apparatus of an embodiment of the invention. In FIG. 1, reference numeral 200 denotes a video/audio information recording/playback apparatus, reference numeral 202 denotes a display unit of for example a TV set. In the video/audio information recording/playback apparatus 200, reference numeral 201 denotes a reservation setting unit, reference numeral 203 denotes video/audio information input unit, reference numeral 204 denotes a recording controller, reference numeral 205 denotes a management information storage, reference numeral 206 denotes a recording medium, reference numeral 207 denotes a playback controller, and reference numeral 208 denotes a playback setting unit. In the recording medium 206, reference numeral 250 denotes a video/audio information recording area, and reference numeral 251 denotes a management information recording area. The video/audio information recording/playback apparatus 200 of this embodiment of the present invention includes the reservation setting unit 201, the video/audio information input unit 203, the recording controller 204, the management information storage 205, and the playback controller 207.

The recording medium is a rewritable medium and can be inserted into and removed from the video/audio information recording/playback apparatus 200. The information recording area of the recording medium 206 is divided into at least two parts, i.e., the video/audio information recording area 250 for recording video/audio information, and the management information recording area 251 for recording management information on the recorded programs (the video/audio information thereof) and the management information on the entire medium.

Although the recording medium 206 is shown to be a disk medium (magnetic disk, optical disk, or the like), which is randomly accessible, it may alternatively be a semiconductor memory or the like which also permits random access, and yet functions similar to those of the disk medium can be realized, and similar merits are attained. Also, a medium, such as a tape which permits only sequential access may be used. In this case, the operation speed is lower, but functions similar to those of a random-access medium can be realized.

The video/audio information recording/playback apparatus 200 according to the invention is for recording broadcast programs containing video/audio information (combination of the video and audio information, or video information alone, or audio information alone) in accordance with reservation information for recording, in a recording medium, and playing back the recorded programs.

The recording controller 204 controls the relevant parts of the apparatus 200 at the time of recording the programs in the recording medium 206.

The video/audio information input unit 203 is controlled by the recording controller 204, and inputs video/audio information to the recording controller 204. For instance, the video/audio information input unit 203 supplies the recording controller 204 with the video/audio information of the channel selected by the recording controller 204.

The recording controller 204 controls recording of the video/audio information (forming a program) supplied from the video/audio information input unit 203 in the recording medium 206.

The reservation setting unit 201 is used to set the reservation information which is used to control the operation for the reserved recording by the recording controller 204, and controls the reserved recording operation of the recording controller 204 in accordance with the reservation information.

The playback controller 207 controls the relevant parts of the apparatus 200 at the time of playing back the programs from the recording medium 206, thereby controlling playback of the programs.

The playback setting unit 208 is used to set the information representing the conditions or manner of playback, which is used to control the operation for playback by the playback controller 207, and controls the playback operations of the playback controller 207.

The management information storage 205 stores the management information which is recorded in the management information recording area 251. The management information storage 205 is preferably a memory which permits random access, and permits access at a higher speed than the recording medium 206.

The recording controller 204 is capable of adding attribute information for grouping a plurality of programs recorded according to the reservation information, to each of the programs recorded according to the reservation information.

The recording controller 204 of the illustrated embodiment is also capable of recording recording mode information indicating whether the program of a certain group maybe recorded in replacement of another program which belongs to the same group and was recorded previously. The recording mode information may be recorded as part of management information, to be described later, and in association with each program or in association with each group. The plurality of programs grouped together may be programs broadcast periodically, e.g., every week, on the same day of the week and the same time of the day (once a week or a plurality of times a week). In such a case, reservation for periodic recording can be made.

When recording a new program which belongs to a certain group, the recording controller 204 selects the area for recording the new program, by judging whether the new program may be recorded in replacement of another program which belongs to the same group and which was recorded previously by referring to the recording mode information.

The reservation setting unit 201 may be adapted to permit input of information by a user to designate the content of the attribute information, and the recording controller 204 may be adapted to determine the content of the attribute information in response to the information supplied from the reservation setting unit. In the illustrated embodiment, programs recorded by a single common reservation are grouped together. In this case, the input for setting a single reservation for a plurality of programs, e.g., periodically broadcast programs, constitutes the input of the information designating the content of the attribute information.

The reservation setting unit 201 may be further adapted to permit input of information by a user to designate the content of the recording mode information, and the recording controller 204 may adapted to determine the content of the recording mode information in response to the information supplied from the reservation setting unit 201.

In the embodiment which will be described in detail, the recording controller 204 adds the attribute information such that a plurality of programs recorded by one common reservation information for periodic recording belong to the same group.

The reservation setting unit 201 is capable of setting the number of programs constituting a unit of update-recording processing, and adds, to the reservation information, information indicating the above-mentioned number of programs. When recording programs by the reservation information, the recording controller 204 records a new program, while preserving the previously recorded program or programs, until the number of recorded programs belonging to the same group reaches the above-mentioned number of programs constituting the unit of update-recording processing, and the recording controller 204 records a new program in replacement of an old program, e.g., the oldest program, of the same group, after the number of recorded programs has reached the above-mentioned number of programs constituting the unit of update-recording processing, so that the above-mentioned number of programs constituting the unit of processing are maintained in the recording medium.

For instance, the reservation setting unit permits setting of the number of programs constituting a unit of update-recording processing, in response to input by a user.

In reservation for periodic recording, the reservation setting unit automatically sets the number of programs broadcast within a predetermined period, e.g., a week, may be automatically and tentatively set as a unit of update recording processing. In this case, it may be altered in response to input by a user.

The video/audio information recording/playback apparatus 200 of the illustrated example has a feature that the recording mode information (i.e., information on whether the update-recording mode is applied or not) and the information indicating the number of programs which constitute a unit of processing are added to the reservation information for periodic recording, and the attribute information for grouping a plurality of programs recorded according to the reservation information for periodic recording is added to the programs recorded according to the reservation information for periodic recording, and whether a recorded program has been recorded according to the reservation information for periodic recording can be identified by the recording mode information for the program, so that the program recorded according to the reservation information for periodic recording is update-recorded in the recording medium taking the above-mentioned number of programs as a unit.

That is, by adding the attribute information for grouping the plurality of programs, to each of the programs recorded by one (common) reservation information for periodic recording, the plurality of programs are update-recorded, being taken as a unit of processing.

Moreover, during playback, the video/audio information recording/playback apparatus 200 takes the plurality of programs grouped by the attribute information as a unit of playback processing, and when the unit of playback processing is selected, the video/audio information recording/playback apparatus 200 performs collective playback (normal playback or special playback (slow playback, scan playback, skip playback, or the like)) of only of the plurality of programs. That is, by forming a unit of playback processing only of the plurality of programs grouped by the attribute information, it is possible to perform collective playback of only the plurality of programs belonging to the same group, continuously, or continuously and cyclically.

The operation of the video/audio information recording/playback apparatus 200 of FIG. 1 will next be described. It is assumed that the program contains video information, but the invention is applicable to programs which do not contain video information, but contain audio information. Before describing the reservation setting operation, the reserved recording operation, and the playback operation, a description on the above-mentioned management information is given.

At the time of starting operation of the video/audio information recording/playback apparatus, i.e., when the power supply to the video/audio information recording/playback apparatus 200 is turned on, when a recording medium 206 is inserted into the video/audio information recording/playback apparatus 200, or like events happens, the management information recorded in the management information recording area 251 of the recording medium 206 is reproduced by the playback controller 207, and sent to and stored in the management information storage 205. Accordingly, the management information is stored in the management information recording area 251 as well as in the management information storage 205.

During the operation of the video/audio information recording/playback apparatus 200, when it is necessary to refer to or update the management information, the recording controller 204 or the playback controller 207 accesses the management information storage 205, and refers to or updates the management information stored in the management information storage 205. The reservation setting unit 201 can refer to or update, through the recording controller 204, the management information stored in the management information recording area 251 or the management information storage 205. The playback setting unit 208 can refer to or update, through the playback controller 207, the management information stored in the management information recording area 251 or the management information storage 205.

At the time of stopping operation of the video/audio information recording/playback apparatus 200, i.e., when the recording medium 206 is removed from the video/audio information recording/playback apparatus 200, or when the video/audio information recording/playback apparatus 200 is switched to a waiting mode, or when the power supply to the video/audio information recording/playback apparatus 200 is turned off, or when the state of the apparatus otherwise changes dynamically, the recording controller 204 uses the management information stored in the management information storage 205 to overwrite the management information recording area 251 and updates the management information in the management information recording area 251.

In this way, by storing the management information in the management information storage 205, which is provided in addition to the recording medium 206, and having the management information storage 205 accessed, and having the management information stored in the management information storage 205 referred to or updated, when a need to refer to or update the management information arises during operation of the video/audio information recording/playback apparatus 200, the time required for referring to or updating the management information can be shorted. However, if the time for accessing the management information recording area 251 of the recording medium 206 during operation is not a problem, it may be so arranged that the management information recording area is accessed when a need to refer to or update the management information arises. In this case, the management information storage 205 may be eliminated.

The management information includes medium management information (e.g., the recording capacity of the entire medium, the vacant capacity, vacant area information for identifying the vacant areas, and the like) for managing the entire medium 206, and program management information for managing each of the programs recorded in the video/audio information recording area 250 of the medium 206. The program management information is generated by the recording controller 204, e.g., for each of the recorded programs. Parameters constituting the program management information includes information on the recording date, such as “recorded channel,” and “recording date,” as well as “attribute information” for grouping a plurality of programs recorded by one (common) reservation information for periodic recording, and “recording area information” for identifying the area in which each program is recorded.

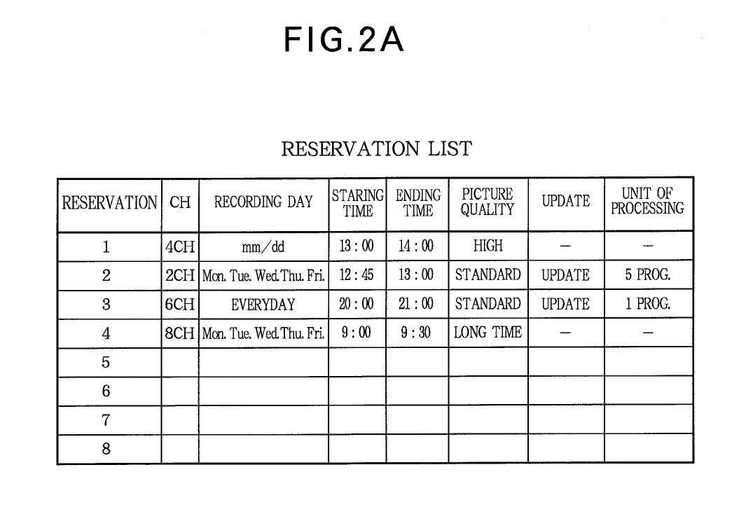

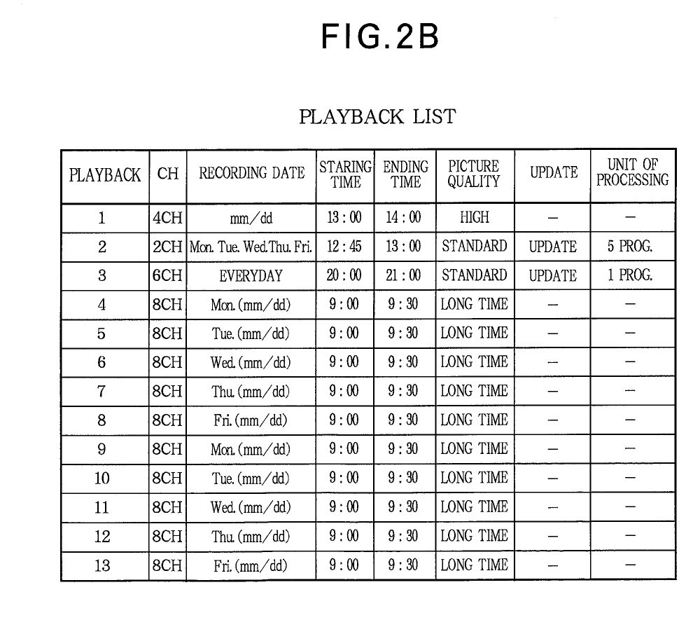

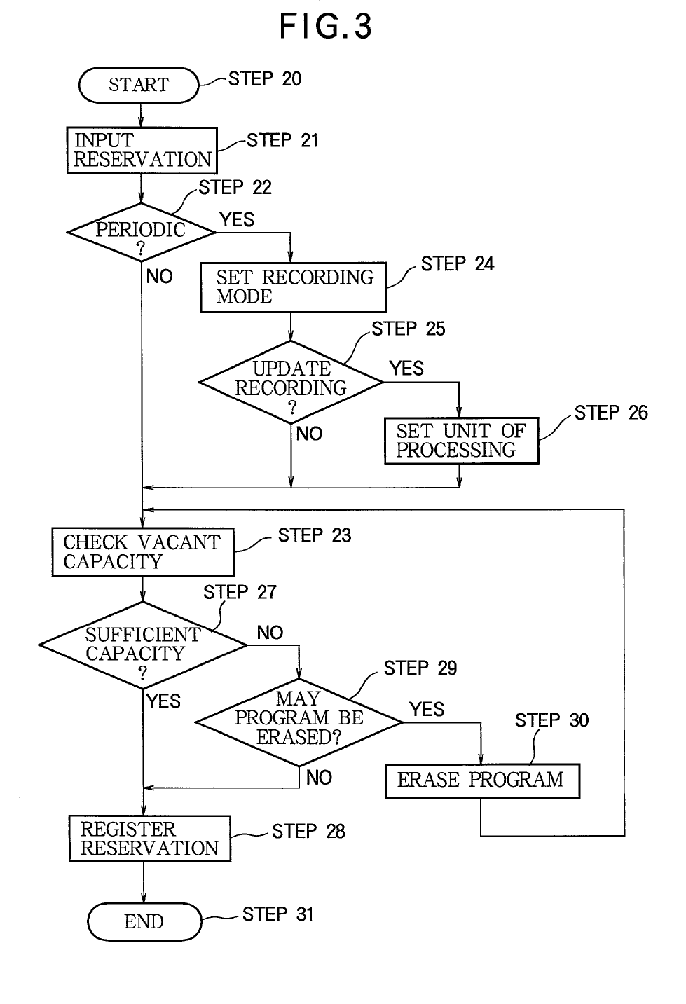

FIG. 2A and FIG. 2B show an example of a reservation list (in the form of a table) and playback list (table) displayed on the display unit 202 in FIG. 1. FIG. 2A shows a reservation list, and FIG. 2B shows a playback list. FIG. 3 is a flowchart illustrating the procedure for reservation setting by means of the reservation setting unit 201 in FIG. 1. First, the reservation setting procedure by means of the reservation setting unit 201 is explained referring to FIG. 2A and FIG. 3.

When the reservation setting mode is started by user manipulation (step 20), the reservation setting unit 201 edits the reservation information which it manages, into the form of a reservation list shown in FIG. 2A, and causes it to be displayed on the display unit 202. The user inputs parameters required by the reservation list displayed on the display unit 202 (step 21).

The user sets parameters such as “recorded channel,” “recording day,” “record starting time,” “record ending time,” and “recording rate (picture quality),” in the items (i.e., columns) titled “CH,” “recording day,” “starting time,” “ending time,” and “picture quality” and the like in the reservation list. The recording day may be set by specifying a particular day, or by periodic setting (such as setting “every day,” “every Monday”, “every Tuesday,” “every Thursday,” “every Friday,” “every Saturday,” “every Sunday,” “everyone of Monday, Tuesday, Wednesday, Thursday, and Friday,” “every one of Monday, Tuesday, Wednesday, Thursday, Friday, and Saturday,” and “every one of Saturday and Sunday”). The parameters set by the user are not limited to those described above, and may include “genre mark”, depending on the recording system.

In connection with the reservation for periodic recording, the “recording mode” is set in the item “updating”in the reservation list. For the recording mode, one of the “update-recording” (“updating”) or “addition-recording” (“-”) is set. The addition-recording is a method in which the periodically recorded programs are recorded in vacant areas, rather than by replacement of previously recorded programs. The update-recording is a method in which the periodically recorded programs are update-recorded, i.e., recorded in replacement of (effectively erasing) previously recorded programs, taking each program or a plurality of programs as a unit. In connection with the reservation for which the update-recording has been set (replacement is permitted when another program of the same group is recorded) “unit of update-recording processing” is set as “one program”, “five programs”, or the like, in the item “unit of processing” in the reservation list in FIG. 2A.

In the reservation list shown in FIG. 2A, four reservations in total, i.e., “reservation No. 1” to “reservation No. 4” (“1” to “4” in item “reservation”). Each of the reservations Nos. 2, 3 and 4 is a reservation for which periodic recording day is set. The reservation No. 1 is a reservation for a program on a specific day. Among the reservations for periodic recording, the reservations Nos. 2 and 3 are reservations for which update-recording is set. The reservation No. 2 is for update-recording for which five programs on Monday, Tuesday, Wednesday, Thursday and Friday are taken as a unit of processing. The reservation No. 3 is for update-recording for which one program is taken as a unit of processing. The reservation No. 4 is for periodic recording, but update-recording is not set, so that each program is not recorded in replacement of previously recorded programs, but is recorded in addition to the previously recorded programs in the recording medium 206.

When parameters are input by the user in step 21 in FIG. 3, the reservation setting unit 201 makes judgment on whether the recording day is periodic or not (step 22). If the recording day is not periodic, the setting of the recording mode and the setting of the unit of processing are bypassed, and the next step performed is a mode for checking the vacant capacity (step 23). If the recording day is periodic, the next step performed is a mode for setting the recording mode (step 24).

In the recording mode setting mode (step 24), the recording mode is set to be the “update-recording” (as indicated by “update”) or “addition-recording” (as indicated by “-”) in the item “update” in the reservation list in FIG. 2A, according to the input by the user.

Next, whether the setting made in the recording mode setting mode (step 24) is for update-recording or not is judged (step 25). If it is not for the update-recording (it is for addition-recording), the setting of the unit of processing is bypassed, and the next step performed is the mode for checking the vacant capacity (step 23). If it is for the update-recording, the next step performed is the mode for setting the unit of processing (step 26).

In the mode for setting the unit of processing (step 26), the unit of processing for the update-recording is set (as “five programs”, “one program” or the like) in the item “unit of processing” in the reservation list shown in FIG. 2A, and the next step performed is the mode for checking the vacant capacity (step 23).

In the mode for setting the unit of processing of step 26, the periodic unit (the number of programs recorded in a week) set in the item “recording day” in the reservation list shown in FIG. 2A is automatically set as the unit of processing. For instance, if the recording day has been set as “everyday” the unit of processing is automatically set to be seven programs. If the recording day has been set as “Monday, Tuesday, Wednesday, Thursday, Friday” the unit of processing is automatically set to be five programs. In this connection, the arrangement is such that user confirmation is requested with regard to the automatically set unit of processing. For instance, the automatically set unit of processing is displayed in the item “unit of processing” in the reservation list shown in FIG. 2A. If the user wants to change the unit of processing, such a change is permitted.

In the mode for checking the vacant capacity (step 23), the vacant capacity of the recording medium 206 is checked. Next, the result of the vacant capacity check and the capacity required for recording the reserved program are compared (step 27). If, as a result of the comparison, the vacant capacity is not less than the capacity required for recording the reserved program, the reservation being attempted is registered (step 28), and the reservation setting is completed (step 31). If the vacant capacity is less than the capacity required for recording the reserved program, the next step performed is the step 29.

In the above-mentioned mode of checking the vacant capacity in step 23, the reservation setting unit 201 checks the vacant capacity of the recording medium 206, by referring to the medium management information stored in the management information storage 205, via the recording controller 204. In the above-mentioned step 27, the reservation setting unit 201 estimates the capacity required for recording the reserved program based on the set recording time and recording rate.

If, in the step 27, the vacant capacity is less than the capacity required for recording the reserved program, it is necessary to erase the program(s) previously recorded in the recording medium 206. In this connection, the user is made to make a choice between erasure of a previously recorded program to secure the recording area, or forced registration of the reservation without securing the recording area, and hence with insufficient recording area (step 29). If the user chooses the option of erasing a previously recorded program to secure the recording area, the program to be erased is selected by the user, and the selected program is erased (step 30). The next step performed is the mode for checking the vacant capacity (step 23). If the user chooses the option of the forced registration of the reservation without securing the recording area, and hence with insufficient recording area, the reservation being attempted is registered (step 28), and the reservation setting is completed (step 31).

In the step 30, the reservation setting unit 201 refers to the program management information stored in the management information storage 205, via the recording controller 204, and displays the list of the already-recorded programs on the display unit 202, and erases the program management information of the program selected by the user, from among the program management information of the programs stored in the management information storage 205, and updates the vacant capacity of the medium and vacant area information, stored in the management information storage 205.

The reservation setting unit 201 stores and manages the reservation information registered by the step 28. Parameters constituting the reservation information include the “recorded channel,” “recording day,” “record starting time,” “record ending time,” “recording rate (picture quality),” and “recording mode,” which are set by the user, as well as “reservation number” for identifying the reservation information (which correspond to “1,” “2,” . . . in the item “reservation” in the reservation list of FIG. 2A), and the “recording capacity” required for recording the reserved program, as estimated in the step 27. The reservation setting unit 201 adds the “unit of update-recording processing” automatically set or changed by the user, to the reservation information for which the update-recording has been set. Information for grouping a plurality of programs may be formed to serve as information indicating the unit of update-recording processing.

Next, the reserved recording operation is described. The reservation setting unit 201 manages the reserved recording, in accordance with the above-described reservation information, and when it is a predetermined time before the starting time of the reserved recording, the reservation setting unit 201 activates the video/audio information recording/playback apparatus 200 (if the power supply to the video/audio information recording/playback apparatus 200 has been off), and forms recording management information on the basis of the reservation information, and sends this recording management information to the recording controller 204, and causes the video/audio information recording/playback apparatus 200 to be in a recording waiting mode.

Parameters constituting the recording management information may include “recorded channel,” “recording calendar (recording month/day/day-of-week),” “record starting time,” “record ending time,” “recording rate (picture quality,” “recording mode,” “recording capacity,” and “reservation number.” In the case of a reserved recording by means of reservation information for which update-recording has been set, the “unit of update-recording processing” is also added as a parameter of the recording management information. Information for grouping a plurality of programs may be formed to serve as information indicating the unit of update-recording processing.

The recording controller 204 sets the channel of the video/audio information input unit 203 in accordance with the “recorded channel” of the above-mentioned recording management information, and determines or selects the recording area to be used for recording the reserved program, based on the above-mentioned recording management information, as well as the program management information of each already-recorded program, and the medium management information stored in the management information storage 205, and generates “recording area information” for identifying the recording area.

When it is time to start recording, in the mode of waiting for reserved recording, the reservation setting unit 201 controls the recording controller 204, to start the reserved recording. The recording controller 204 records the program (video/audio information) input from the video/audio information input unit 203, in the recording area of the recording medium 206, at the “recording rate (picture quality)” of the recording management information.

When it is time to stop the recording, the reservation setting unit 201 controls the recording controller 204 to stop the recording. The recording controller 204 generates program management information of the program having been recorded by reservation, based on the above-mentioned recording management information, and updates the management information stored in the management information storage 205.

The parameters of the above-mentioned program management information may include “recorded channel,” “recording calendar (recording month/day/day-of-week),” “record starting time,” “record ending time,” “recording rate (picture quality,” “recording mode,” and “recording capacity.” The recording controller 204 adds the “recording area information” for identifying the recording area having been selected, and “program number” for identifying the program management information in the management information stored in the management information storage 205, as parameters of the program management information. In the case of program management information of a program recorded according to reservation information for which update-recording has been set, the recording controller 204 also adds the “unit of update-recording processing” and the “attribute information” as parameters.

The above-mentioned “attribute information” is information for grouping a plurality of programs recorded by means of one (common) reservation information for which update-recording has been set. The recording controller 204 sets the “attribute information” based on the “recording mode,” “reservation number,” and the like of the above-mentioned recording management information. For each of the programs recorded by means of one (common) reservation information for which update-recording has been set, attribute information which enables identification that the program belongs to a certain group is set, and for different groups of the programs which are recorded by means of different reservation informations for which update-recording has been set, attribute informations which enable identification that they (the respective programs) belong to different groups are set.

The attribute information may be one which in its entirety identifies the group, or one part of which identifies the group. For instance, if “reservation number 1” and “reservation number 2” are both reservation with update-recording, “attribute 1” may be set for all the programs recorded by the reservation No. 1, or “attribute A1,” “attribute A2,” . . . , may be set for the respective ones of these programs, and “attribute 2” may be set for all the programs recorded by the reservation No. 2, or “attribute B1,” “attribute B2,” . . . , may be set for the respective one of these programs. Each of the entirety of the “attribute 1” and “attribute 2” is for identifying the group, and each of the part (“A” or “B”) of the attribute A1, A2, B1 and B2 is for identifying the group.

Here, the attribute information is set by the recording controller 204 based on the reservation information (“recording mode,” “reservation number,” and the like). But it is also possible to add auxiliary information (such as link information between programs, and the order of arrangement of the programs) which facilitates setting of the above-described attribute information, to the recording management information generated by the reservation setting unit 201, or to have the recording management information include the attribute information itself. The recording day and time of each of the respective programs recorded, being grouped by the attribute information, can be identified based on the “recording calendar” constituting the program management information together with the attribute information, but it is also possible to include the information on the recording day and time in the management information, to enable identification of the recording day and time of each of the already recorded programs at the time of update-recording.

In the case of reserved recording for which update-recording is not set (recording of another program in replacement of the program in question is prohibited), the recording controller 204 determines the recording capacity of the reserved program, by referring to the “recording capacity” of the recording management information, and determines the vacant area (its position and capacity) of the recording medium 206, by referring to the “vacant area information” of the medium management information, and selects the area in which the reserved program is to be recorded, on the basis of the determined recording capacity and vacant area, and additionally taking into consideration the position of the recording head. The recording area is selected from among the vacant areas. The recording controller 204 adds the program management information of the program having been recorded by reservation, to the management information in the management information storage 205, and rewrites the vacant area information in the medium management information.

In the case of the reserved recording for which update-recording has been set (recording of one program in replacement of another program is permitted), the recording controller 204 determines the recording capacity of the reserved program, by referring to the “recording capacity” of the recording management information, determines the vacant area (its position and capacity) of the recording medium 206, by referring to the “vacant area information” of the medium management information, and determines the unit of update-recording processing, and the number of programs, recording areas, the recording day and time, and the like of the programs having been recorded by means of the update-recording, by referring to the “unit of update-recording processing,” “attribute information,” “recording area information,” and “recording calendar” of the program management information stored in the management information storage 205, and selects the area in which the reserved program is to be recorded, based on the thus determined recording capacity, vacant area, and unit of update-recording processing, as well as the number of programs, recording areas, and recording day and time of the programs already recorded, and additionally taking into consideration the position of the recording head. The recording area is selected from among the areas in which the programs have been update-recorded, or vacant areas.

In the case of update-recording for which the unit of processing is set to be a plurality of programs (update recording taking a plurality of programs as a unit), each reserved program is addition-recorded in a vacant area, until the number of programs recorded in the recording medium 206 by means of the update-recording reaches the number of programs set as the unit of processing. The program management information of the program having been addition-recorded is added to the management information in the management information storage 205, and the vacant area information in the medium management information is rewritten or updated.

After the number of recorded programs has reached the number of programs having been set as the unit of processing, in the case of update-recording taking each group of programs as a unit, the reserved program is recorded (by overwriting) in the recording area of the temporally oldest program among the plurality of programs having been recorded by means of the update-recording (i.e., the temporally oldest program in the group of programs), or is addition-recorded in a vacant area if there is such a vacant area.

If the recording area of the oldest program is overwritten, the recording calendar of the program management information of the oldest program is overwritten by the recording calendar of the program having been newly recorded, so that the program management information of the oldest program is replaced by the program management information of the newly recorded program. In this case, if the recording area of the newly recorded program is the same as the recording area of the oldest program, the recording controller 204 need not generate the recording area information for the newly recorded program, and need not rewrite the vacant area information in the medium management information. When the addition-recording has been performed in a vacant area, the recording calendar and the recording area information of the program management information of the oldest program are respectively replaced by the recording calendar and recording area information of the newly recorded program, so that the program management information of the oldest program is replaced by the program management information of the newly recorded program, and the vacant area information in the medium management information is updated.

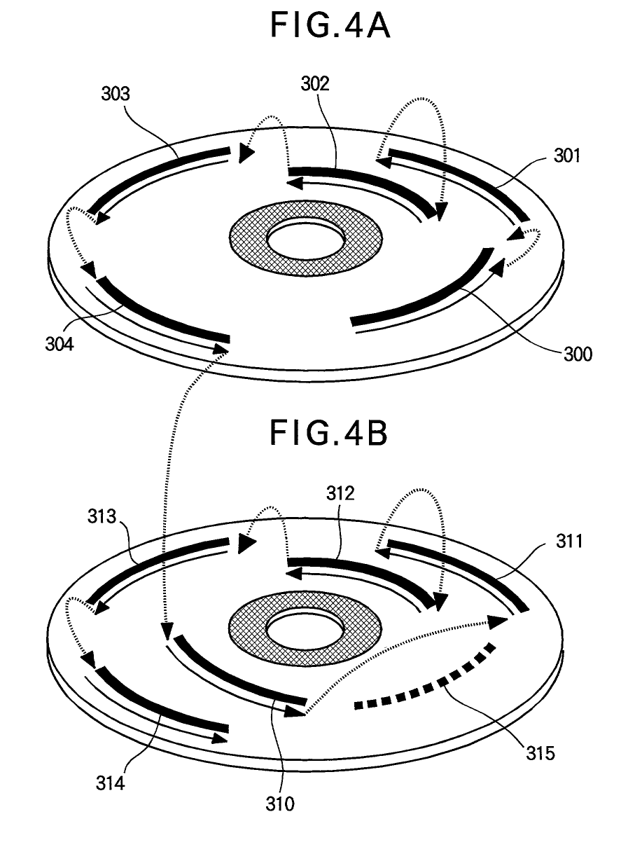

FIG. 4A and FIG. 4B illustrate the update-recording operation taking a plurality of programs as a unit, by means of the video/audio information recording/playback apparatus 200 of the embodiment of the invention. It illustrates the update-recording operation for the reservation number 2 (the unit of processing is five programs) in FIG. 2A. It is assumed that attribute information “attribute 2” is set for the reservation No. 2 in FIG. 2A.

FIG. 4A schematically illustrates recording during a first cycle (of recording according to the reservation information for periodic recording). FIG. 4B schematically illustrates update-recording during a second cycle. In FIG. 4A, reference numeral 300 denotes an area used for recording a program on Monday, reference numeral 301 denotes an area used for recording a program on Tuesday, reference numeral 302 denotes an area used for recording a program on Wednesday, reference numeral 303 denotes an area used for recording a program on Thursday, and reference numeral 304 denotes an area used for recording a program on Friday. In FIG. 4B, reference numeral 310 denotes an area used for update-recording a program on Monday, reference numeral 311 denotes an area used for update-recording a program on Tuesday, reference numeral 312 denotes an area used for update-recording a program on Wednesday, reference numeral 313 denotes an area used for update-recording a program on Thursday, and reference numeral 314 denotes an area used for update-recording a program on Friday. The areas 301 and 311 are identical to each other, and so are the areas 302 and 312, the areas 303 and 313, and the areas 304 and 314. However, the areas 300 and 310 are different from each other. The area 300 used for recording the program on Monday during the first cycle as shown in FIG. 4A is the area 315 in FIG. 4B. In FIG. 4A and FIG. 4B, the thick lines indicate the areas in which the programs are recorded, and the arrow-headed thin lines indicate the direction of recording operation, and the arrow-headed broken lines indicate the relationship between the areas.

On Monday during the first cycle (which is a first week in the example under consideration), the program management information of “attribute 2” identical to that of the attribute information of reservation No. 2 is not present in the management information in the management information storage 205, so that the program is recorded in an area 300 which has been vacant, and the program management information of the program with its attribute information being “attribute 2” is added to the management information. On Tuesday during the first cycle, there is only one program management information of “attribute 2” in the above-mentioned management information, and the number of recorded programs has not reached five which is the number of programs constituting a unit of processing. Accordingly, the program is recorded in an area 301 which has been vacant, and the program management information (with attribute information being “attribute 2”) of this program is added to the above-mentioned management information. Similarly, on Wednesday, Thursday and Friday during the first cycle, the programs are recorded in areas 302, 303 and 304 which have been vacant, and the program management information (with their attribute information being “attribute 2”) of each of these programs is added to the above-mentioned management information. By the reserved recording on Friday during the first cycle, the number of program management information with “attribute 2” in the management information becomes five, so that the number of programs with “attribute 2” in the recording medium 206 becomes five which is the number of programs constituting a unit of processing.

On Monday during the second cycle (which in this case is a second week), the number of programs with “attribute 2” identical to the attribute information of the reservation No. 2 has already reached five which is the number of programs constituting a unit of processing, so that the new program is recorded in the area 300 where the oldest program among the five programs with “attribute 2” is recorded, or in a vacant area. In this case, it is assumed that an area 310 which has been vacant is selected, and the program on Monday during the second cycle is recorded in this area 310. The recording calendar of the program management information of the program recorded on Monday during the first cycle is replaced by the recording calendar of the program recorded on Monday during the second cycle, and the recording area information (information signifying the area 300) of the program management information on Monday during the first cycle is replaced by the recording area information (information signifying the area 310) on Monday during the second cycle. In this way, the program management information on Monday during the first cycle is replaced by the program management information on Monday during the second cycle. By the rewriting of the program management information, the program recorded on Monday during the first cycle is effectively overwritten by the program on Monday during the second cycle.

The program on Tuesday during the second cycle is recorded in the area 301 where the oldest program among the five programs with the attribute information being “attribute 2,” or in a vacant area. Here, it is assumed that the area 301 is selected, and the program on Tuesday during the second cycle is recorded in the area 301. The recording calendar of the program management information for Tuesday during the first cycle is replaced by the recording calendar for Tuesday during the second cycle. In this way, the program management information for Tuesday during the first cycle is replaced by the program management information for Tuesday during the second cycle.

Similarly, the areas 302, 303 and 304 are selected on Wednesday, Thursday and Friday during the second cycle, and the programs on Wednesday, Thursday and Friday during the second cycle are update-recorded in these areas 302, 303 and 304, and the recording calendar of the program management information for each of Wednesday, Thursday and Friday during the first cycle is replaced by the recording calendar of the program management information for each of Wednesday, Thursday and Friday during the second cycle. In this way, the program management information for Wednesday, Thursday and Friday during the first cycle is replaced by the program management information for Wednesday, Thursday and Friday during the second cycle.

In this way, the video/audio information recording/playback apparatus 200 adds, to the reservation information for periodic recording for which update-recording is set, the recording mode information and the information on the number of programs constituting a unit of processing, and the attribute information for grouping a plurality of programs recorded according to the reservation information), and adds the information for update-recording to the programs recorded according to the reservation information, and identifies whether the already program has been recorded by the particular reservation information, based on the above-mentioned attribute information, at the time of reserved recording. In this way, the program according to the reservation information can be update-recorded in the recording medium, and it is possible to realize update-recording taking any number of programs of, for instance, one cycle or several cycles, as a unit of processing. That is, in connection with reservation for periodic recording for which update-recording is set taking a plurality of programs as a unit, the attribute information for grouping the plurality of programs recorded by the particular reservation is added to the programs recorded by the particular reservation, and these programs are taken as one unit of update processing during reserved recording by means of update-recording.

In addition, the video/audio information recording/playback apparatus 200 records the management information including the attribute information in the recording medium 206 together with the programs when the recording operation is stopped, the recording medium 206 is removed, when there is a transition to a waiting mode, when the power supply to the apparatus is turned off, or some other similar event happens, and the video/audio information recording/playback apparatus 200 reproduces the management information including the attribute information from the recording medium 206 and stores it in the management information storage 205 when the apparatus is activated, when the recording medium 206 is inserted, or when some other similar event happens. Accordingly, compatibility between a plurality of video/audio information recording/playback apparatus 200 can be secured, and programs can be update-recorded taking any number of programs as a unit, in a single recording medium 206 (that is, the programs of the same group can be recorded using different video/audio information recording/playback apparatus 200), and yet it is possible to collectively reproduce only the programs of the same group that have been update-recorded.

The video/audio information recording/playback apparatus 200 divides the information recording area of the recording medium 206 into video/audio information recording area 250 for recording programs, and management information recording area 251 for recording management information, and the management information for all the programs recorded in the video/audio information area 250 is collectively recorded in the management information area 251, so that temporal response at the time of reading management information from the recording medium and rewriting management information of the recording medium can be improved (time required for reading and writing can be shortened), and the erroneous operation during reading and writing of management information can be reduced.

The video/audio information recording/playback apparatus 200 does not limit the area for recording the newest program to the area where an old program was recorded, as in the prior art example, but the newest program may be recorded selectively in an area where an old program was recorded, or any vacant area. Accordingly, an optimum recording area can be selected depending for instance on the position of the writing head, and the temporal response up to the start of recording can be improved. The reason that the newest program need not be recorded in a limited area, but may be recorded in a vacant area is that the programs recorded in the recording medium 206 are managed collectively by means of the program management information, and by updating the program management information, the newest program is made to effectively replace an old program.

Operation during playback is next described with reference to FIG. 2B. When a playback mode is started by user's manipulation, the playback setting unit 208 generates playback management information based on the program management information stored in the management information storage 205, and edits the playback management information into the form of a playback list shown in FIG. 2B, and displays it on the display unit 202. The user selects the playback number of the program which he wants to play back, from the playback list displayed on the display unit 202. The playback setting unit 208 controls the playback controller 207, to cause playback of the program of the selected playback number.

Based on the attribute information of the respective program management information, the playback setting unit 208 forms units of playback processing such that a plurality of programs recorded by means of one (common) reservation information for update-recording, and grouped by the attribute information (or a single program if the unit of update-recording processing is “1,”) constitute a single unit of playback processing, and each of the programs to which attribute information is not attached forms, by itself, a unit of playback processing, and the playback setting unit 208 generates playback management information for each unit of playback processing.

Parameters for the playback management information may include “recorded channel,” “recording calendar (recording month/day/day-of-week),” “record starting time,” “record ending time,” “recording rate (picture quality” (“high picture quality,” “standard,” “long time (i.e., long play)” or the like), “recording mode,” and “recording capacity.” The playback setting unit 208 adds the “playback number” for identifying the playback management information, and the “playback program information” which is used for relating the playback management information with the program management information stored in the management information storage 205, as parameters of the playback management information. The playback setting unit 208 adds, to the playback management information of the unit of playback processing formed of the program or programs which have been recorded according to reservation information for which update-recording is set, “the unit of playback processing,” which is the number of programs constituting the unit of playback processing (or the information for grouping a plurality of programs, or information for linking between programs, or the like) as a parameter.

The playback number mentioned above is for identifying the playback management information, like the reservation number of the reservation information, or the program number of the program management information, and corresponds to “1,” “2,” . . . , in the item “playback” in the playback list of FIG. 2B.

The playback program information mentioned above is information for relating the playback management information of the unit of playback processing, with the program management information of one or more programs constituting a unit of playback processing, for the purpose of identifying the programs constituting the unit of playback processing. For example, the recording area information or the program number(s) of the program management information of the program(s) constituting the unit of playback processing, is set as the playback program information. If the unit of playback processing is formed of a plurality of programs recorded by update-recording taking a plurality of programs as a unit, the recording are information or programs numbers of the plurality of programs are set as the playback program number.

The items “playback,” “CH,” “recording day,” “starting time,” “ending time,” “picture quality,” “update,” “unit of processing” in the playback list in FIG. 2B are used for displaying the “playback number,” “recorded channel,“ “recording calendar (recording month/day/day-of-week),” “record starting time,” “record ending time,” “recording rate (picture quality),” “recording mode,” and “unit of playback processing (“five programs,” “one program,” or the like),” respectively. Information indicating the “unit of processing” may be attribute information for grouping a plurality of programs.

In the playback list of FIG. 2B, a plurality of programs recorded by reservation for which update-recording has been set, taking the plurality of programs as a unit, are displayed collectively in the same way a single program is displayed. Programs recorded by reservation for which update-recording has been set for a single program, or by reservation for which update-recording has not been set, are displayed one by one, as in the prior art.

The “reservation No. 1” in FIG. 2A is a reservation for a specific day, and no attribute information is attached to the program recorded by the reservation No. 1, so that the single program recorded by the reservation No. 1 constitutes a unit of playback processing by itself. The “playback No. 1” in FIG. 2B is for playing back a single program recorded by the reservation No. 1.

The “reservation No. 3” in FIG. 2A is a reservation for periodic recording and the recording mode is set to be update-recording (as the item “update” is set to be update (rather than “-” or addition-recording)), so that attribute information of “attribute 3” for example is attached to the program recorded by the reservation No. 3. As the unit of update-recording processing (“unit of processing” in FIG. 2A) is set to be “1,” the number of programs recorded by the reservation No. 3 on the recording medium 206 is just one. Thus, the newest program recorded by reservation No. 3 constitutes a unit of playback processing by itself. The “playback No. 3” in FIG. 2B is for playing back a newest program recorded by the reservation No. 3, and the unit of playback processing of the playback No. 3 (item ”unit of processing” in FIG. 2B) is set as “1. ”

The “reservation No. 4” in FIG. 2A is a reservation for periodic recording, but the recording mode is set to be “addition-recording,” (as “-” is set in the item “update”) no attribute information is attached to the programs recorded by the reservation No. 4. Accordingly, each of the programs recorded by the reservation No. 4 constitutes a unit of playback processing by itself. Each of the “playback No. 4” to “playback No. 13” in FIG. 2B is for playing back a single program recorded by the reservation No. 4.

The “reservation No. 2” in FIG. 2A is a reservation for periodic recording, and the recording mode is set as update-recording, so that attribute information of “attribute 2” for example is attached to the programs recorded by the reservation No. 2. The unit of update-recording processing for the reservation No. 2 is set to be “five programs.” Accordingly, the (maximum) number of programs recorded by the reservation No. 2 on the recording medium 206 is five, and attribute information of “attribute 2” is attached to the five programs recorded by reservation No. 2, so that the five programs recorded by the reservation No. 2 constitute a single unit of playback processing. The “playback No. 2” in FIG. 2B is for collectively (and sequentially) playing back the five programs recorded by the reservation No. 2, and the unit of playback processing of the playback No. 2 is “five.”

Based on the playback program information set in the playback management information of the selected playback number, the playback setting unit 208 sets the program number of the program to be played back, in the playback controller 207. The playback controller 207 searches the management information stored in the management information storage unit 205 for the program management information of the program number that has been set, and uses the recording area information in the program management information to identify the area where the program to be played back is recorded, and plays back the program recorded in the area.

When the playback number of a unit of playback processing formed of a plurality of programs periodically recorded is selected, the program numbers of the plurality of programs are set in the playback controller 207, and the playback controller 207 collectively performs consecutive (sequential), or consecutive and cyclical playback of only these programs. The playback may be normal playback or special playback (slow playback, scan playback, skip playback or the like).

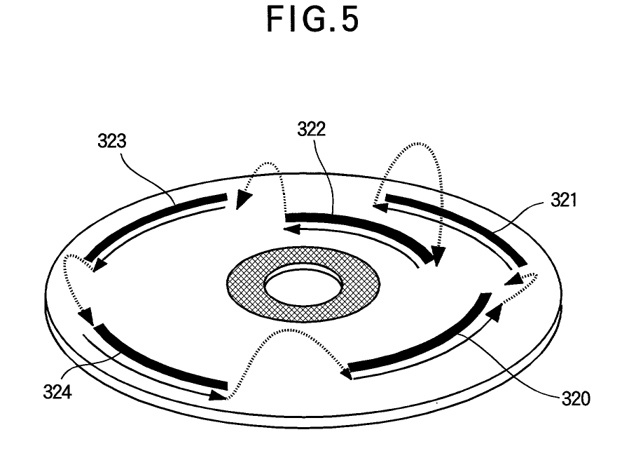

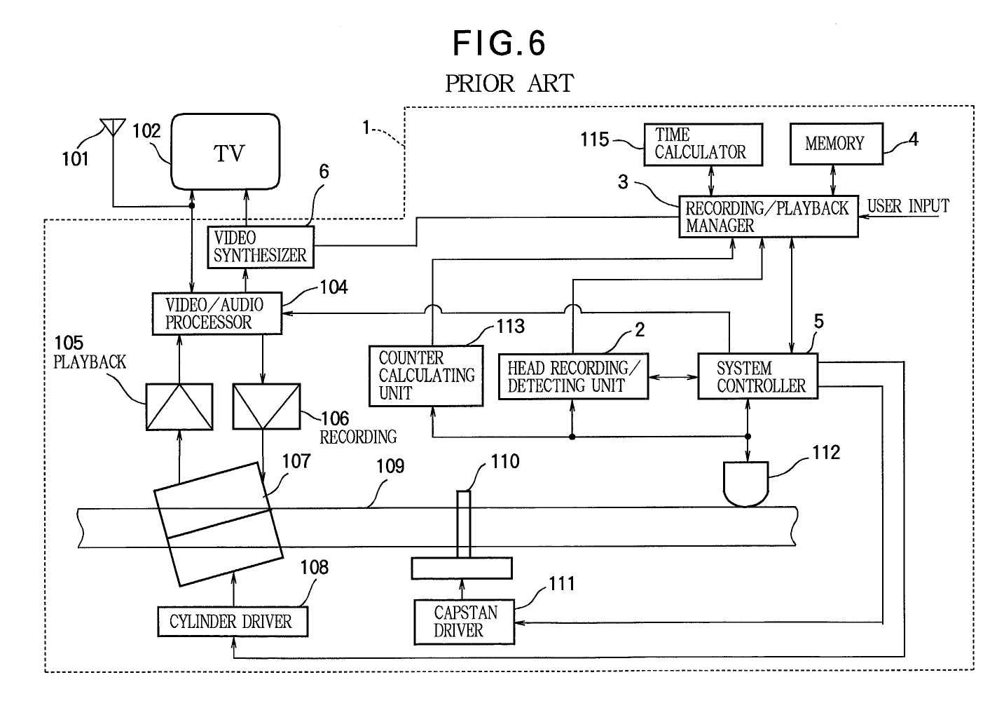

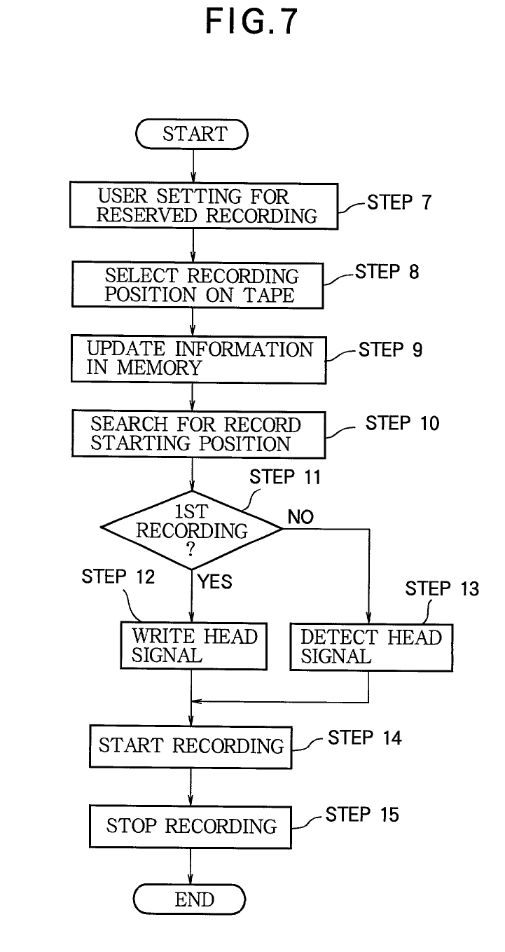

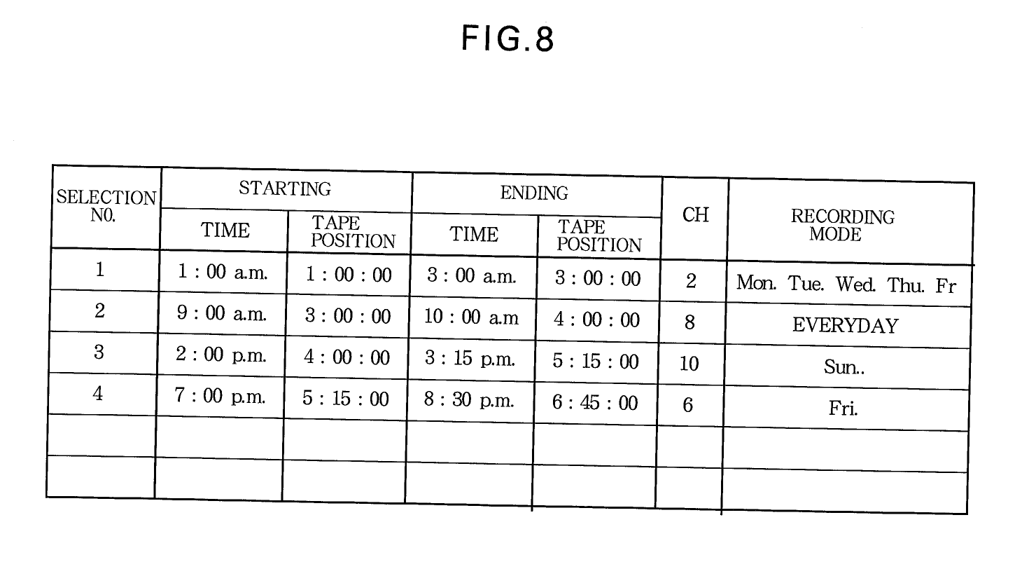

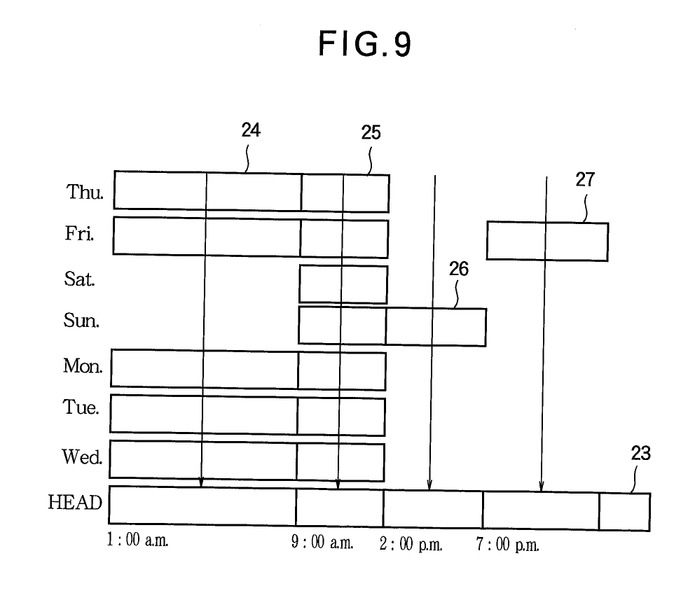

FIG. 5 illustrates collective playback of a plurality of programs recorded by update-recording taking a plurality of programs as a unit, by the video/audio information recording/playback apparatus 200 of the embodiment of the invention. It illustrates an operation for consecutively (sequentially) and cyclically playing back the five programs of the playback No. 2 of FIG. 2B (the five programs update-recorded by the reservation No. 2 in FIG. 2A). In FIG. 5, reference numeral 320 denotes an area where the program on Monday was recorded, reference numeral 321 denotes an area where the program on Tuesday was recorded, reference numeral 322 denotes an area where the program on Wednesday was recorded, reference numeral 323 denotes an area where the program on Thursday was recorded, and reference numeral 324 denotes an area where the program on Friday was recorded. The thick solid line indicates the area where the programs are recorded, thin solid arrow-headed lines indicate the direction of playback operation, and broken arrow-headed lines indicate jumps between areas.

First, the area 320 where the program on Monday was recorded is played back, starting from the head of the area 320. Then, the playback head jumps to the head of the area 321 where the program on Tuesday was recorded, and the area 321 is played back. Then, the playback head jumps to the head of the area 322 where the program on Wednesday was recorded, and the area 322 is played back. Then, the playback head jumps to the head of the area 323 where the program on Thursday was recorded, and the area 323 is played back. Then, the playback head jumps to the head of the area 324 where the program on Friday was recorded, and the area 324 is played back. Then, the playback head jumps to the head of the area 320 where the program on Monday was recorded, and the area 320 is played back again. In this way, only the five programs which were recorded in the areas 320, 321, 322, 323 and 324 and constitute the unit of playback processing of the playback No. 2 are played back consecutively and cyclically. It is also possible to perform playback of only the five programs consecutively (sequentially), just once each. The playback may be normal playback or special playback (slow playback, scan playback, skip playback or the like).

In this way, the video/audio information recording/playback apparatus 200 adds, to the program management information of each of a plurality of programs recorded by reservation for periodic recording for which update-recording taking a plurality programs as a unit has been set, attribute information for grouping the plurality of programs, so that it is possible to identify the plurality of programs having been recorded by one (common) reservation for which update-recording taking a plurality of programs as a unit, in accordance with the attribute information, during playback. Accordingly, a unit of playback processing is formed only of a plurality of programs which were update-recorded by one (common) reservation information for periodic recording and which relate closely to each other, and when the unit of playback processing is selected, consecutive, or consecutive and cyclic playback of only the plurality of programs taken collectively can be made. In other words, by appending attribute information to a plurality of programs recorded by reservation for a periodic recording for which update-recording has been set taking a plurality of programs as a unit, so as to group the plurality of programs, the plurality of programs can be handled as a unit of playback processing during playback, and it is possible to perform playback of only the plurality of programs which have been recorded by reservation for update-recording taking a plurality of programs as a unit and which relate closely to each other, taken collectively. The playback may be normal playback or special playback (slow playback, scan playback, skip playback or the like).

As has been described according to the above-described embodiment, the recording mode information and the attribute information are added to reservation information for periodic recording, the attribute information for grouping the plurality of programs recorded according to the reservation information for periodic recording is added to the programs recorded according to the reservation information for periodic recording, whether an already-recorded program was recorded according to reservation information for periodic recording or not can be identified based on the attribute information for the program, programs according to the reservation information for periodic recording are update-recorded in the recording medium taking the plurality of programs as a unit, so that the unit of update-recording processing in reservation information for periodic recording can be enlarged to an arbitrary number, from just one as in the conventional art.

For making the features of the invention more effective, it is preferable that the recording medium is a medium in which any position in the medium can be accessed at a high speed (i.e., a medium permitting a high-speed random access). Disk media which permit random access (such as optical disks, magnetic disks,) or semiconductor memories are preferred to recording media such as tape media which permit only sequential access.

In the illustrated embodiment described, programs recorded by a single common reservation are grouped together. In this case, the input for setting a single reservation for a plurality of programs, e.g., periodically broadcast programs, constitutes the input of the information designating the content of the attribute information. However, the manner of setting for the grouping is not limited to that of the example described. For instance, programs broadcast from time to time (not necessarily “periodically”) under the same title may be grouped together, programs of the same genre, such as news programs, or children's programs, may be grouped together, or related programs such as a program with a certain title (program a) broadcast by a certain channel (channel A) and a program with another title (program b) broadcast by another channel (channel B) may be grouped together. In the last case, two programs broadcast everyday may be grouped together, and may be update-recorded taking each day as a unit, i.e., taking the two programs as a unit.

In the embodiment described, after the number of recorded programs has reached the above-mentioned number of programs constituting the unit of update-recording processing, the recording controller 204 records a new program in replacement of the oldest program of the same group. However, the recording controller 204 may be formed to record a new program in replacement of any other previously recorded program, i.e., an old program of the same group, such as the one which has a common nature as the new program to be recorded, e.g., one previously recorded on the same day-of-week, or one with the same title (where programs of different titles in the same genre are made to belong to the same group).

In the embodiment described, the recording medium is shown to comprise a single disk. However, the recording medium may alternatively comprise a plurality of disks associated with an automatic disk changer.

In the embodiment described, when the vacant capacity is checked in step 23 in FIG. 3, the capacity of the areas where no programs are recorded at the time of the reservation is determined. However, it is also possible to take into consideration the recording capacity of earlier reservation(s), i.e., the recording capacity of the one or more programs for which reservation for recording has been made at the time of the attempted reservation. In this case, the recording capacity of the attempted reservation is compared with the vacant capacity minus the recording capacity of the earlier reservation(s).

What is claimed is:

1. A video/audio information recording/playback apparatus recording programs containing video/audio information (combination of video and audio information, or video information alone, or audio information alone) in accordance with reservation information for recording, in a recording medium, and playing back the recorded programs, including:
a recording controller for controlling recording of the programs in a recording medium;
a reservation setting unit for controlling reserved recording operation by the recording controller in accordance with the reservation information;
a playback controller for controlling playback of the programs recorded in the recording medium; and
a playback setting unit for controlling the playback operation by the playback controller;
wherein the recording controller is capable of adding attribute information for grouping a plurality of programs recorded according to reservation information, to each of the programs recorded according to the reservation information.

2. The video/audio information recording/playback apparatus as set forth in claim 1, wherein the recording controller is capable of recording recording mode information indicating whether the program of each group may be recorded in replacement of another program which belongs to the same group and was recorded previously.

3. The video/audio information recording/playback apparatus as set forth in claim 2, wherein, when recording a new program which belongs to a certain group, the recording controller selects the area for recording the new program, by judging whether the new program may be recorded in replacement of another program which belongs to the same group and which was recorded previously, by referring to the recording mode information.

4. The video/audio information recording/playback apparatus as set forth in claim 1, wherein the reservation setting unit permits input of information by a user to designate the content of the attribute information, and the recording controller determines the content of the attribute information in response to the information from the reservation setting unit.

5. The video/audio information recording/playback apparatus as set forth in claim 2, wherein the reservation setting unit permits input of information by a user to designate the content of the recording mode information, and the recording controller determines the content of the recording mode information in response to the information from the reservation setting unit.

6. The video/audio information recording/playback apparatus as set forth in claim 1, wherein
the reservation setting unit is capable of setting the number of programs constituting a unit of update-recording processing, and adds, to the reservation information, information indicating the above-mentioned number of programs; and
when recording programs by the reservation information, the recording controller records a new program, while preserving the previously recorded program or programs, until the number of recorded programs belonging to the same group reaches the above-mentioned number of programs constituting said unit of update-recording processing, and the recording controller records a new program in replacement of an old program of the same group, after the number of recorded programs has reached the above-mentioned number of programs constituting said unit of update-recording processing.

7. The video/audio information recording/playback apparatus as set forth in claim 6, wherein the reservation setting unit permits setting of the number of programs constituting a unit of update-recording processing, in response to input by a user.

8. The video/audio information recording/playback apparatus as set forth in claim 1, wherein the recording controller adds the attribute information such that a plurality of programs recorded by one common reservation information for periodic recording belong to the same group.

9. The video/audio information recording/playback apparatus as set forth in claim 6, wherein, in reservation for periodic recording, the reservation setting unit automatically sets the number of programs within a predetermined period as a unit of update recording processing.

10. The video/audio information recording/playback apparatus as set forth in claim 9, wherein the reservation setting unit is capable of altering the number of programs constituting said unit of update-recording processing having been set automatically, in response to input by a user.

11. The video/audio information recording/playback apparatus as set forth in claim 1, wherein
the playback setting unit takes the plurality of programs grouped by the attribute information as one unit of playback processing; and
the playback controller performs collective playback of only those grouped programs when said unit of playback processing is selected.

12. The video/audio information recording/playback apparatus as set forth in claim 1, wherein the record controller records the attribute information together with the program in the recording medium.

13. The video/audio information recording/playback apparatus as set forth in claim 1, wherein the recording controller divides the information recording area of the recording medium into a video/audio information area and a management information area, and records the programs in the video/audio information area, and records management information for the programs in the management information area, and also records the attribute information for the programs recorded according to the reservation information, as part of the management information for the program in the management information area.

14. The video/audio information recording/playback apparatus as set forth in claim 13, wherein, when recording a new program in replacement of another program which was recorded previously, the recording controller selects the area for recording the new program by means of the reservation information, from among an area where the above-mentioned another program is recorded, and a vacant area; and erases the management information for above-mentioned another program, and records the management information for the new program.

15. The video/audio information recording/playback apparatus as set forth in claim 13, further including a management information storage being separate from the recording medium, and storing the management information; wherein
the playback controller reproduces the management information from the recording medium and supplies the management information to the management information storage at the time of starting of operation of the video/audio information recording/playback apparatus;
the recording controller and the playback controller access the management information storage when it is required to refer to or rewrite the management information during operation of the video/audio information recording/playback apparatus; and
the recording controller replaces the management information stored in the recording medium with the management information stored in the management information storage at the time of stopping of the operation of the video/audio information recording/playback apparatus.

16. The video/audio information recording/playback apparatus as set forth in claim 15, wherein said starting of operation of the video/audio information recording/playback apparatus is turning-on of the power supply to the video/audio information recording/playback apparatus, or insertion of a recording medium into the video/audio information recording/playback apparatus.

17. The video/audio information recording/playback apparatus as set forth in claim 15, wherein said stopping of the operation of the video/audio information recording/playback apparatus is removal of a recording medium from the video/audio information recording/playback apparatus, transition of the video/audio information recording/playback apparatus to a waiting mode, or turning-off of the power supply to the video/audio information recording/playback apparatus.

18. The video/audio information recording/playback apparatus as set forth in claim 1, wherein the recording medium is a randomly accessible medium.

19. A video/audio information recording/playback method including:
setting reservation information;
recording programs containing video/audio information (combination of video and audio information, or video information alone, or audio information alone) in accordance with the reservation information, in a recording medium; and
adding attribute information for grouping a plurality of programs recorded according to reservation information, to each of the programs recorded according to the reservation information.

20. The video/audio information recording/playback method as set forth in claim 19, further including:
setting the number of programs constituting a unit of processing;
recording information representing the above-mentioned number of programs together with the program recorded according to the reservation information;
recording a new program, while preserving the previously recorded program or programs, until the number of recorded programs belonging to the same group reaches the above-mentioned number of programs constituting said unit of processing; and
recording a new program in replacement of an old program of the same group, after the number of recorded programs has reached the above-mentioned number of programs constituting said unit of processing.
